(19) United States
(12) Patent Application Publication
(10) Pub. No.: US 2007/0078648 A1
(43) Pub. Date: Apr. 5, 2007

(54) AUDIO PROCESSING SYSTEM AND METHOD FOR HEARING PROTECTING

(75) Inventors: Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,417

(22) Filed: Aug. 4, 2006

(30) Foreign Application Priority Data
Sep. 5, 2005 (TW) 094130298

(51) Int. Cl. G10L 21/00

(52) U.S. Cl. 704/225

(57) ABSTRACT

The present invention relates to an audio processing method for hearing protecting, includes steps of: fetching an audio file; decoding the audio file and generating digital audio signals; sampling the digital audio signals thereby obtaining a plurality of amplitude values; obtaining a current gain value; calculating an accumulated audio energy value during a predetermined time interval by sampling amplitude values in the predetermined time interval and the current gain value; automatically reduce the current gain value or outputting a prompt signal to prompt a user to manually reduce the current gain value when the accumulated audio energy value reaches a predetermined value; whereby protecting users' hearing. The present invention also provides a corresponding audio processing system for protecting users' hearing.

### TECHNICAL FIELD

The present invention relates to an audio processing system and method for hearing protecting, especially to an audio processing system and method for evaluating audio energy in advance, and automatically adjusting a current gain value or outputting a prompt signal according to the evaluated audio energy.

### GENERAL BACKGROUND

The continuous development of new digital technology has helped portable audio devices (such as MP3 player) become popular among people. When environmental noise external of the portable audio device is loud or when a favorite song is played, a user commonly increases a volume of a portable device. However users all have a physiological hearing threshold, i.e., loudness discomfort level (LDL). If the user is exposed to an environment with a noise volume level that is larger than the user's LDL for a long time, the user's hearing may be damaged.

In order to solve the problems mentioned, there is a common gain control system and method available in the market. The gain control system and method provides a gain value limit and forbids adjusting the gain value beyond the gain value limit. However, the system and method is rigid and not user friendly.

Therefore, a heretofore unaddressed need exists in the industry to overcome the aforementioned deficiencies and inadequacies.

### SUMMARY

In order to solve said problems, the present invention provides an audio processing system and method for protecting users' hearing.

The audio processing method for hearing protecting includes steps of: sampling digital audio signals decoded thereby obtaining a plurality of amplitude values mi; obtaining a current gain value V; calculating an accumulated audio energy Q during a predetermined time interval T by sampling amplitude values mi in the predetermined time interval T and the current gain value V; determining whether the accumulated audio energy Q reaches a predetermined value K; and generating a hearing protection signal if the accumulated audio energy Q reaches a predetermined value K.

The audio processing system for hearing protecting includes a storage unit, a processing unit, a decoding unit, a gain control unit and a gain management unit. The gain management unit controlled by the processing unit, samples digital audio signals decoded by the decoding unit thereby obtaining a plurality of amplitude values mi; obtains a current gain value V from the storage unit; calculates an accumulated audio energy Q during a predetermined time interval T by sampling amplitude values mi in the predetermined time interval T and the current gain value V; determining whether the accumulated audio energy Q reaches a predetermined value K; and generating a hearing protection signal if the accumulated audio energy Q reaches a predetermined value K.

The audio processing system for hearing protecting includes a storage unit, a processing unit, a decoding unit, and a gain control unit. The processing unit includes a sampling module for sampling digital audio signals decoded by the decoding unit thereby obtaining a plurality of amplitude values mi; an obtaining module for obtaining a current gain value V from the storage unit; a calculating module for calculating an accumulated audio energy Q during a predetermined time interval T by sampling amplitude values mi in the predetermined time interval T and the current gain value V; and a detecting module for determining whether the accumulated audio energy Q reaches a predetermined value K, and generating a hearing protection signal if the accumulated audio energy Q reaches a predetermined value K.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a block diagram of a hardware infrastructure of an audio processing system for hearing protecting in accordance with first preferred embodiment of the present invention;

FIG. 2 is a schematic diagram of main function modules of a gain management unit of FIG. 1;

FIG. 3 is a common flowchart of playing an audio file;

FIG. 4 is a flowchart of a preferred audio processing method for hearing protecting by utilizing the system of FIG. 1;

FIG. 5 is a block diagram of a hardware infrastructure of an audio processing system for hearing protecting in accordance with a second preferred embodiment of the present invention; and

FIG. 6 is a schematic diagram of main function modules of a processing unit of FIG. 5.

### DETAILED DESCRIPTION OF THE PREFERRED EMBODIMENTS

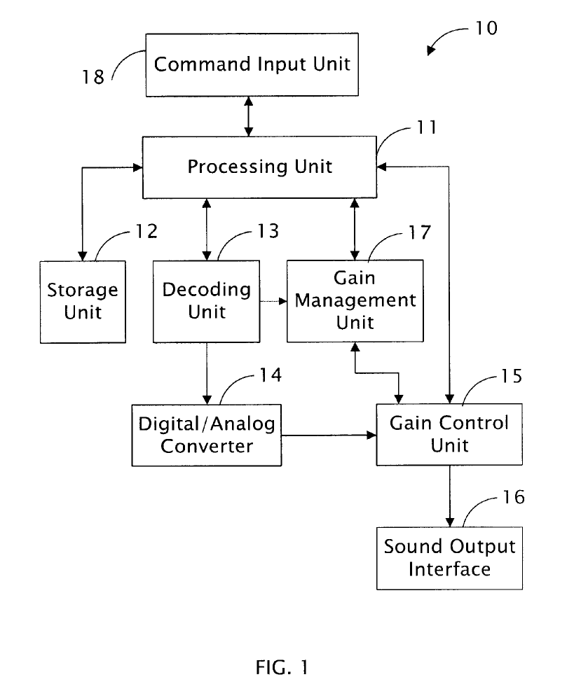

FIG. 1 is a block diagram of a hardware infrastructure of an audio processing system for hearing protecting in accordance with first preferred embodiment of the present invention. The audio processing system 10 includes a processing unit 11, a storage unit 12, a decoding unit 13, a digital/analog (D/A) converter 14, a gain control unit 15, a sound output interface 16, a gain management unit 17, and a command input unit 18. The storage unit 12 stores a plurality of audio files, a current gain value V, and a decoding program. The storage unit 12 can be a flash storage, a hard disk driver, and the like. The processing unit 11 controls a plurality of the system 10 elements, i.e., the storage unit 12, the decoding unit 13, the gain control unit 15, the gain management unit 17 and the command input unit 18. The processing unit 11 can be a digital signal processor (DSP), a central processing unit (CPU), and the like.

The command input unit 18 generates a command in response to an input selection of the user. The command includes a command for playing an audio file and a command for adjusting the current gain value V. The processing unit 11 fetches the audio file from the storage unit 12 in response to the command for playing the audio file.

The decoding unit 13 activates the decoding program stored in the storage unit 12, decodes the audio file fetched from the storage unit 12 and generates digital audio signals. The D/A converter 14 converts the digital audio signals from the decoding unit 13 to generate analog audio signals.

The gain control unit 15 amplifies the analog audio signals from the D/A converter 14 according to the current gain value V. The sound output interface 16 sends the analog audio signals amplified by the gain control unit 15 to an earphone or a speaker (not shown) being connected therein.

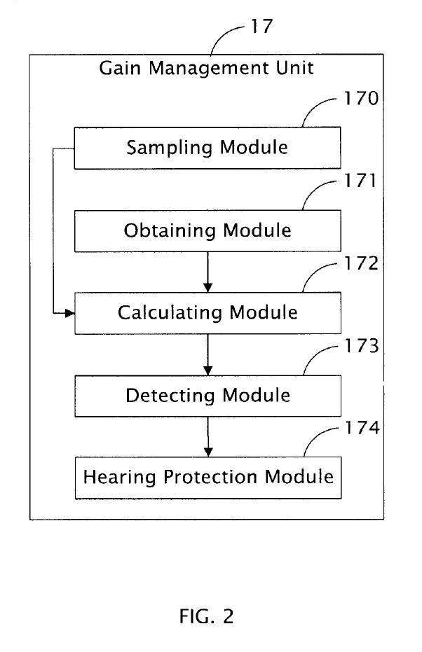

Reference to FIG. 2, the gain management unit 17 includes a sampling module 170, an obtaining module 171, a calculating module 172, a detecting module 173, and a hearing protection module 174. The sampling module 170 samples the digital audio signals from the decoding unit 13 thereby obtaining a plurality of amplitude values mi. The obtaining module 171 obtains the current gain value V stored in the storage unit 12.

The calculating module 172 calculates an accumulated audio energy Q during a predetermined time interval T by the amplitude values mi sampled by the sampling module 170 and the current gain value V, according to an algorithm. The algorithm is: Q=[Σ(mi*V)2/N]½, where i is any natural number, and N presents a count of the amplitude values mi sampled in the predetermined time interval T.

The detecting module 173 determines whether the accumulated audio energy Q reaches a predetermined value K; and if the accumulated audio energy Q reaches the predetermined value K, the detecting module 173 generates a hearing protection signal. The predetermined value K is an upper threshold allowable for a user's hearing.

The hearing protection module 174 controls the gain control unit 15 to automatically reduce the current gain value V to a reduced gain value V according to the hearing protection signal, and stores the reduced gain value to the storage unit 12 to update the current gain value stored therein. Then, the gain control unit 15 amplifies the analog audio signals from the D/A converter 14 according to the reduced gain value V, and sends the analog audio signals amplified to an earphone or speaker (not shown) via the sound output interface 16.

In other preferred embodiment, the hearing protection module 174 may generate a prompt signal to prompt a user to manually reduce the current gain value V according to the hearing protection signal. Then the gain control unit 15 amplifies the prompt signal, and sends the prompt signal amplified to an earphone or a speaker (not shown) via the sound output interface 16. Furthermore, the hearing protection module 174 may also directly send the prompt signal generated to the earphone or the speaker (not shown) via the sound output interface 16.

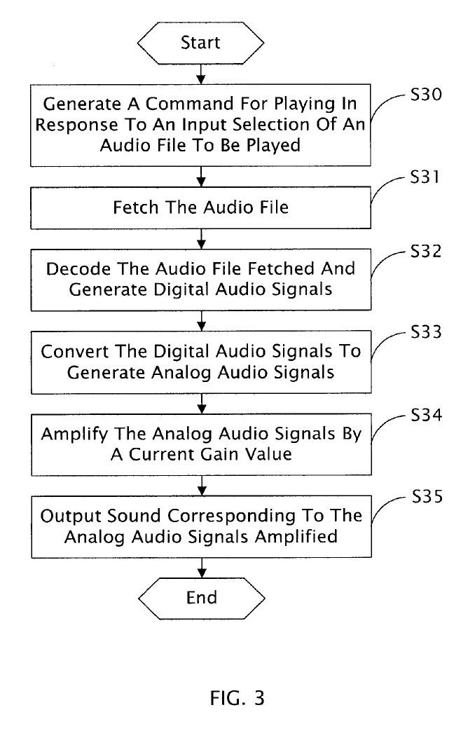

FIG. 3 is a common flowchart of playing an audio file. In step S30, the command input unit 18 generates the command for playing the audio file in response to the input selection of the audio file to be played. In step S31, the processing unit 11 fetches the audio file from the storage unit 12 in response to the command generated by the command input unit 18.

In step S32, the decoding unit 13 decodes the audio file fetched from the storage unit 12 and generates digital audio signals. In step S33, the D/A converter 14 converts the digital audio signals from the decoding unit 13 to generate analog audio signals.

In step S34, the gain control unit 15 amplifies the analog audio signals from the D/A converter 14 according to the current gain value V stored in the storage unit 12. In step S35, the sound output interface 16 outputs the analog audio signals amplified to the earphone or the speaker (not shown) being connected therein, and the earphone or the speaker thereupon outputs sound corresponding to the analog audio signals amplified.

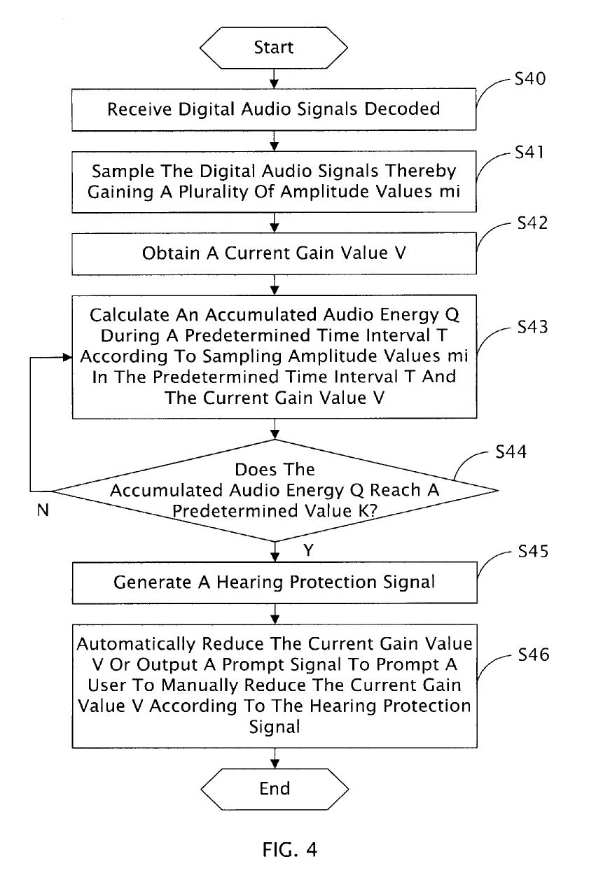

FIG. 4 is a flowchart of a preferred audio processing method for hearing protecting by utilizing the system of FIG. 1. In step S40, the sampling module 170 receives the digital audio signals from the decoding unit 13. In step S41, the sampling module 170 samples the digital audio signals thereby obtaining a plurality of amplitude values mi of the digital audio signals sampled.

In step S42, the obtaining module 171 obtains the current gain value V from the storage unit 12. In step S43, the calculating module 172 calculates the accumulated audio energy Q during the predetermined time interval T by sampling amplitude values mi in the predetermined time interval T and the current gain value V.

In step S44, the adjusting module 173 determines whether the accumulated audio energy Q reaches the predetermined value K, if the accumulated audio energy Q does not reach the predetermined value K, the procedure goes to step S41. If the accumulated audio energy Q reaches the predetermined value K, in step S45, the detecting module 173 generates the hearing protection signal.

In step S46, the hearing protection module 174 controls the gain control unit 15 to automatically reduce the current gain value V or outputs the prompt signal to prompt a user to manually reduce the current gain value V according to the hearing protection signal.

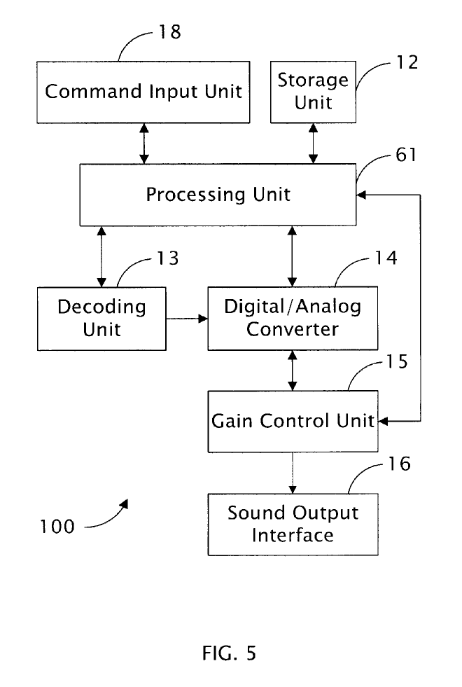

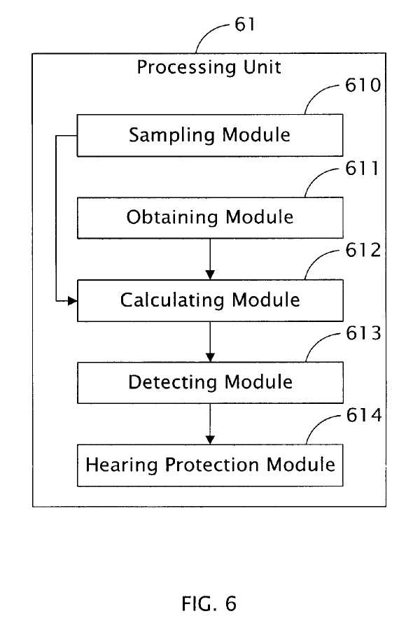

FIG. 5 is a block diagram of a hardware infrastructure of an audio processing system for hearing protecting in accordance with a second preferred embodiment of the present invention. The difference between the second preferred embodiment and the first preferred embodiment is that the audio processing system 100 of the second embodiment does not include the gain management unit 17 and a processing unit 61 performs the functions thereof. Referring to FIG. 6, the processing unit 61 includes a sampling module 610, an obtaining module 611, a calculating module 612, a detecting module 613, and a hearing protection module 614, which respectively performs the same functions as the sampling module 170, the obtaining module 171, the calculating module 172, the detecting module 173, and the hearing protection module 174 of the gain management unit 17 in the first preferred embodiment.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. An audio processing method for hearing protecting, the method comprising steps of:
sampling digital audio signals decoded thereby obtaining a plurality of amplitude values mi;
obtaining a current gain value V;
calculating an accumulated audio energy Q during a predetermined time interval T by sampling
amplitude values mi in the predetermined time interval T and the current gain value V;
determining whether the accumulated audio energy Q reaches a predetermined value K; and
generating a hearing protection signal if the accumulated audio energy Q reaches the predetermined value K.

2. The audio processing method for hearing protecting according to claim 1, the method further comprising a step of: automatically reduce the current gain value V according to the hearing protection signal.

3. The audio processing method for hearing protecting according to claim 1, the method further comprising a step of: outputting a prompt signal according to the hearing protection signal.

4. The audio processing method for hearing protecting according to claim 1, wherein the accumulated audio energy Q is calculated according to an algorithm, and the algorithm is: Q=[Σ(mi*V)2/N ]½, where i is any natural number, and N presents a count of the amplitude values mi sampled in the predetermined time interval T.

5. An audio processing system for hearing protecting, the system comprising:
a storage unit, for storing a plurality of audio files and a current gain value V;
a processing unit, for fetching an audio file from the storage unit;
a decoding unit, for decoding the audio file fetched by the processing unit to generate digital audio signals;
a digital/analog converter, for converting the digital audio signals to generate analog audio signals;
a gain control unit, for amplifying the analog audio signals generated by the digital/analog converter according to the current gain value V;
a gain management unit controlled by the processing unit, sampling the digital audio signals generated by the decoding unit thereby obtaining a plurality of amplitude values mi; obtaining the current gain value V from the storage unit; calculating an accumulated audio energy Q during a predetermined time interval T by sampling amplitude values mi in the predetermined time interval T and the current gain value V; determining whether the accumulated audio energy Q reaches a predetermined value K; and generating a hearing protection signal if the accumulated audio energy Q reaches a predetermined value K.

6. The audio processing system for hearing protecting according to claim 5, wherein the gain management unit further automatically controls the gain control unit to reduce the current gain value V according to the hearing protection signal.

7. The audio processing system for hearing protecting according to claim 5, wherein the gain management unit further outputs a prompt signal according to the hearing protection signal.

8. The audio processing system for hearing protecting according to claim 5, wherein the accumulated audio energy Q is calculated according to an algorithm, and the algorithm is: Q=[Σ(mi*V)2/N]½; where i is any natural number, and N presents a count of the amplitude values mi sampled in the predetermined time interval T.

9. An audio processing system for hearing protecting, the system comprising:
a storage unit, for storing a plurality of audio files and a current gain value V;
a processing unit, for fetching an audio file from the storage unit;
a decoding unit, for decoding the audio file fetched by the processing unit to generate digital audio signals;
a digital/analog converter, for converting the digital audio signals to generate analog audio signals;
a gain control unit, for amplifying the analog audio signals generated by the digital/analog converter according to the current gain value V;
wherein the processing unit comprises:
a sampling module for sampling digital audio signals generated by the decoding unit thereby obtaining a plurality of amplitude values mi;
an obtaining module for obtaining the current gain value V from the storage unit;
a calculating module for calculating an accumulated audio energy Q during a predetermined time interval T by sampling amplitude values mi in the predetermined time interval T and the current gain value V; and
a detecting module for determining whether the accumulated audio energy Q reaches a predetermined value K, and generating a hearing protection signal if the accumulated audio energy Q reaches a predetermined value K.

10. The audio processing system for hearing protecting according to claim 9, wherein the processing unit further comprises a hearing protection module for automatically controlling the gain control unit to reduce the current gain value V according to the hearing protection signal.

11. The audio processing system for hearing protecting according to claim 9, wherein the processing unit further comprises a hearing protection module for outputting a prompt signal according to the hearing protection signal.

12. The audio processing system for hearing protecting according to claim 9, wherein the accumulated audio energy Q is calculated according to an algorithm, and the algorithm is: Q=[Σ(mi*V)2/N]½; where i is any natural number, and N presents a count of the amplitude values mi sampled in the predetermined time interval T.
